(19) United States
(12) Patent Application Publication
(10) Pub. No.: US 2026/0034755 A1
(43) Pub. Date: Feb. 5, 2026

(54) DEVICE FOR ASSEMBLING DISPLAYS

(71) Applicant: Samsung Display Co., LTD., Yongin-si (KR)

(72) Inventors: Gyu Seong SHIM, Yongin-si (KR); Chang Hyung LEE, Yongin-si (KR); Jin HYUN, Yongin-si (KR); Do Hyung RYU, Yongin-si (KR)

(21) Appl. No.: 19/077,907

(22) Filed: Mar. 12, 2025

(30) Foreign Application Priority Data
Aug. 5, 2024 (KR) 10-2024-0104162

(51) Int. Cl. B30B 15/02; B30B 9/00

(52) U.S. Cl. CPC B30B 15/02; B30B 9/00

(57) ABSTRACT

Disclosed is a device for assembling displays. The device for assembling displays may provide a relatively high pressure per unit area to edges of a display panel during assembly of the displays.

This application claims priority to Korean Patent Application No. 10-2024-0104162, filed on Aug. 5, 2024, and all the benefits accruing therefrom under 35 U.S.C. § 119, the content of which in its entirety is herein incorporated by reference.

### TECHNICAL FIELD

Embodiments of the present disclosure relate to a device for assembling displays.

### BACKGROUND

In the case of a display forming a curved surface, stress may be concentrated on edges of a display panel during a process of coupling a cover glass and the display panel. In this case, difficulties may occur in forming a curvature of the display panel due to the concentrated stress.

### SUMMARY

An object of the present disclosure is to provide a device for assembling displays, which applies a relatively high pressure per unit area to edges of the display panel.

To achieve the above object, according to an aspect of embodiments of the present disclosure, there is provided a device for assembling displays including: an upper jig which includes an upper jig pressing surface, wherein the upper jig pressing surface extends from a first upper jig edge to a second upper jig edge in a longitudinal direction of the device and is convex downward; and a lower jig positioned below the upper jig and including a lower jig pressing surface, wherein the lower jig pressing surface extends from a first lower jig edge to a second lower jig edge in the longitudinal direction, is concave and faces the upper jig pressing surface, and has a curvature which varies along the lower jig pressing surface in the longitudinal direction.

In some embodiments, a reference plane may be formed in the longitudinal direction and a vertical direction, and the curvature of the lower jig pressing surface is a curvature of a curve formed by the lower jig pressing surface on the reference plane.

In some embodiments, the lower jig pressing surface may include: a lower jig pressing surface central region forming a central portion of the lower jig pressing surface; and a lower jig pressing surface edge region extending from the lower jig pressing surface central region to a perimeter of the lower jig pressing surface.

In some embodiments, a curvature of the lower jig pressing surface edge region may be greater than a curvature of the lower jig pressing surface central region.

In some embodiments, the curvature of the lower jig pressing surface edge region may increase in a direction from a boundary between the lower jig pressing surface central region and the lower jig pressing surface edge region toward the perimeter of the lower jig pressing surface.

In some embodiments, the curvature of the lower jig pressing surface at a boundary between the lower jig pressing surface central region and the lower jig pressing surface edge region may be smaller than the curvature of the lower jig pressing surface at the perimeter of the lower jig pressing surface.

In some embodiments, the upper jig pressing surface may include: an upper jig pressing surface central region facing the lower jig pressing surface central region; and an upper jig pressing surface edge region extending from the upper jig pressing surface central region to a perimeter of the upper jig pressing surface.

In some embodiments, a curvature ratio may be defined as a ratio of the curvature of the lower jig pressing surface to a curvature of the upper jig pressing surface in the longitudinal direction, and the curvature ratio in the lower jig pressing surface central region may be constant along the lower jig pressing surface in the longitudinal direction.

In some embodiments, the curvature ratio in the lower jig pressing surface edge region may be greater than the curvature ratio in the lower jig pressing surface central region.

In some embodiments, the curvature ratio of the lower jig pressing surface edge region may increase in a direction from a boundary between the lower jig pressing surface central region and the lower jig pressing surface edge region toward the perimeter of the lower jig pressing surface.

According to another aspect of embodiments of the present disclosure, there is provided a device for assembling displays including: an upper jig which includes an upper jig pressing surface, wherein the upper jig pressing surface extends from a first upper jig edge to a second upper jig edge in a longitudinal direction of the device and is convex downward; and a lower jig positioned below the upper jig and including a lower jig pressing surface, wherein the lower jig pressing surface extends from a first lower jig edge to a second lower jig edge in the longitudinal direction, is concave, and faces the upper jig pressing surface, wherein a distance between the upper jig pressing surface and the lower jig pressing surface varies along the upper jig pressing surface and the lower jig pressing surface in the longitudinal direction.

In some embodiments, a reference plane may be formed in the longitudinal direction and a vertical direction, and a distance between the upper jig pressing surface and the lower jig pressing surface may be a distance between two curves respectively formed on the reference plane by the upper jig pressing surface and the lower jig pressing surface.

In some embodiments, the lower jig pressing surface may include: a lower jig pressing surface central region which forms forming a central portion of the lower jig pressing surface; and a lower jig pressing surface edge region extending from the lower jig pressing surface central region to a perimeter of the lower jig pressing surface.

In some embodiments, the upper jig pressing surface may include: an upper jig pressing surface central region which faces facing the lower jig pressing surface central region; and an upper jig pressing surface edge region extending from the upper jig pressing surface central region to a perimeter of the upper jig pressing surface.

In some embodiments, a distance between the upper jig pressing surface central region and the lower jig pressing surface central region may be constant along the lower jig pressing surface in the longitudinal direction.

In some embodiments, a distance between the upper jig pressing surface edge region and the lower jig pressing surface edge region may decrease in a direction from a boundary between the lower jig pressing surface edge region and the lower jig pressing surface central region toward the perimeter of the lower jig pressing surface.

Further, according to another aspect of embodiments of the present disclosure, there is provided a device for assembling displays including: an upper jig which includes an upper jig pressing surface, wherein the upper jig pressing surface extends from a first upper jig edge to a second upper jig edge in a longitudinal direction of the device and is convex downward; and a lower jig positioned below the upper jig and including a lower jig pressing surface, wherein the lower jig pressing surface extends from a first lower jig edge to a second lower jig edge in the longitudinal direction, is concave and faces the upper jig pressing surface, and has a curvature radius which varies along the lower jig pressing surface in the longitudinal direction.

In some embodiments, a reference plane may be formed in the longitudinal direction and a vertical direction, and the curvature radius of the lower jig pressing surface may be a curvature radius of a curve formed by the lower jig pressing surface the reference plane.

In some embodiments, the lower jig pressing surface may include: a lower jig pressing surface central region forming a central portion of the lower jig pressing surface; and a lower jig pressing surface edge region extending from the lower jig pressing surface central region to a perimeter of the lower jig pressing surface, wherein a curvature radius of the lower jig pressing surface edge region may be smaller than a curvature radius of the lower jig pressing surface central region.

In some embodiments, a curvature of the lower jig pressing surface at a boundary between the lower jig pressing surface central region and the lower jig pressing surface edge region may be smaller than a curvature of the lower jig pressing surface at the perimeter of the lower jig pressing surface.

The device for assembling displays according to the embodiments of the present disclosure may apply a relatively high pressure per unit area to the edges of the display panel.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a device for assembling displays according to an embodiment of the present disclosure;

FIG. 2 is a plan view of the device for assembling displays illustrated in FIG. 1;

FIG. 3 is a cross-sectional view illustrating the device for assembling displays taken along line A1-A2 in FIG. 2;

FIG. 4 is a view illustrating a state in which the layers are omitted in FIG. 3;

FIG. 5 is a view illustrating the layers illustrated in FIG. 3;

FIG. 6 is a view illustrating pressing surfaces depending on the position in a longitudinal direction of the device for assembling displays;

FIG. 7 is a graph illustrating a distribution of curvatures of an upper jig pressing surface illustrated in FIG. 6 on an X-axis;

FIG. 8 is a graph illustrating a distribution of curvatures of a lower jig pressing surface illustrated in FIG. 6 on the X-axis;

FIG. 9 is a graph illustrating a ratio of the curvature of the lower jig pressing surface illustrated in FIG. 8 to the curvature of the upper jig pressing surface illustrated in FIG. 7 on the X-axis;

FIG. 10 is a graph illustrating the distribution of curvatures of the lower jig pressing surface illustrated in FIG. 6 on the X-axis, which is a graph illustrating a case where the curvature of a lower jig pressing surface edge region increases linearly;

FIG. 11 is a graph illustrating a ratio of the curvature of the lower jig pressing surface illustrated in FIG. 10 to the curvature of the upper jig pressing surface illustrated in FIG. 7 on the X-axis;

FIG. 12 is a graph illustrating the distribution of curvatures of the lower jig pressing surface illustrated in FIG. 6 on the X-axis, which is a graph illustrating a case where the curvature of the lower jig pressing surface edge region increases nonlinearly; and

FIG. 13 is a graph illustrating a ratio of the curvature of the upper jig pressing surface illustrated in FIG. 7 to the curvature of the lower jig pressing surface illustrated in FIG. 12 on the X-axis.

### DETAILED DESCRIPTION

Embodiments supported by the present disclosure will now be described more fully hereinafter with reference to the accompanying drawings, in which one or more example embodiments are illustrated. Aspects supported by the present disclosure may, however, be embodied in different forms and should not be construed as limited to the embodiments set forth herein. Rather, these example embodiments are provided such that this disclosure will be thorough and complete, and will fully convey the scope of example aspects of the present disclosure to those skilled in the art.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The term “adjacent” herein may refer to elements which are relatively close to each other (e.g., within a threshold distance, without other elements therebetween) or elements which are in contact with each other.

Embodiments are described herein with reference to cross section illustrations that are schematic illustrations of example embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

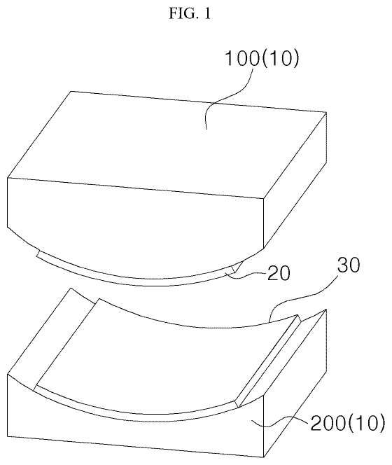

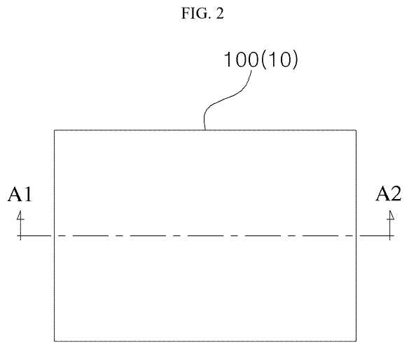

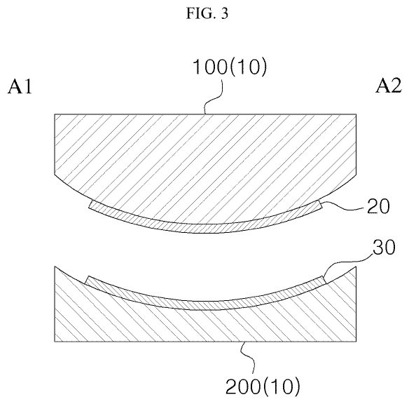

FIG. 1 is a view illustrating a device for assembling displays according to an embodiment of the present disclosure. FIG. 2 is a plan view of the device for assembling displays illustrated in FIG. 1. FIG. 3 is a cross-sectional view illustrating the device for assembling displays taken along line A1-A2 in FIG. 2.

Referring to FIGS. 1 to 3, a device 10 for assembling displays may include an upper jig 100 and a lower jig 200. The upper jig 100 and the lower jig 200 may be arranged in parallel with being spaced apart from each other. For example, the upper jig 100 may be positioned above the lower jig 200.

The upper jig 100 and the lower jig 200 may face each other. For example, a lower surface of the upper jig 100 may face an upper surface of the lower jig 200.

Respective shapes of the upper jig 100 and the lower jig 200 may correspond to each other. For example, the lower surface of the upper jig 100 may be convex. For example, the upper surface of the lower jig 200 may be concave.

An upper layer 20 may be positioned on the lower surface of the upper jig 100. A lower layer 30 may be positioned on the upper surface of the lower jig 200. The upper layer 20 and the lower layer 30 may be coupled with each other to form a display. The layers 20 and 30 may include or mean at least one of the upper layer 20 and the lower layer 30. The terms positioned and disposed may be used interchangeably herein.

The upper layer 20 may be positioned above the lower layer 30. The lower surface of the upper layer 20 may face the upper surface of the lower layer 30. The upper surface of the upper layer 20 may come into contact with the lower surface of the upper jig 100. The lower surface of the lower layer 30 may face the upper surface of the lower jig 200.

At least a portion of the upper jig 100 and the lower jig 200 may move. For example, the upper jig 100 may move up and down with respect to the lower jig 200. For example, the lower jig 200 may move up and down with respect to the upper jig 100.

The upper jig 100 and the lower jig 200 may move toward or away from each other. The upper jig 100 and the lower jig 200 may move toward each other while the upper layer 20 and the lower layer 30 are spaced apart from each other.

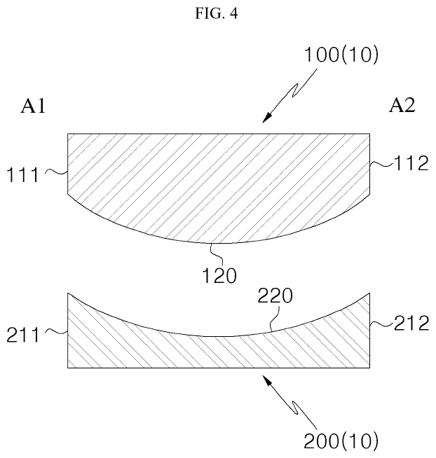

FIG. 4 is a view illustrating a state in which the layers are omitted, i.e., removed from the device in FIG. 3.

Referring to FIGS. 1 and 4, the upper jig 100 may extend from one end to the other end. For example, a first upper jig edge 111 may form one end of the upper jig 100. For example, a second upper jig edge 112 may form the other end of the upper jig 100.

For example, the upper jig 100 may extend from the first upper jig edge 111 to the second upper jig edge 112. A direction in which the upper jig 100 extends may be the longitudinal direction of the upper jig 100. The upper jig edges 111 and 112 may include or mean at least one of the first upper jig edge 111 and the second upper jig edge 112.

The upper jig 100 may include an upper jig pressing surface 120. The upper jig pressing surface 120 may form the lower surface of the upper jig 100. The upper jig pressing surface 120 may be convex. For example, the upper jig pressing surface 120 may be convex downward. The upper jig pressing surface 120 may face the lower jig 200.

The lower jig 200 may extend from one end to the other end. For example, a first lower jig edge 211 may form one end of the lower jig 200. For example, a second lower jig edge 212 may form the other end of the lower jig 200.

For example, the lower jig 200 may extend from the first lower jig edge 211 to the second lower jig edge 212. A direction in which the lower jig 200 extends may be the longitudinal direction of the lower jig 200. The longitudinal direction of the lower jig 200 may be the longitudinal direction of the upper jig 100.

The lower jig edges 211 and 212 may include or mean at least one of the first lower jig edge 211 and the second lower jig edge 212. The longitudinal direction of the device 10 for assembling displays may be the longitudinal direction of the lower jig 200 or the longitudinal direction of the upper jig 100.

The lower jig 200 may include a lower jig pressing surface 220. The lower jig pressing surface 220 may form the upper surface of the lower jig 200. The lower jig pressing surface 220 may face the upper jig pressing surface 120.

The lower jig pressing surface 220 may have a shape corresponding to the shape of the upper jig pressing surface 120. For example, the lower jig pressing surface 220 may be concave. For example, the shape of the lower jig pressing surface 220 may be the same as the shape of the upper jig pressing surface 120.

The upper jig pressing surface 120 may extend from the first upper jig edge 111 to the second upper jig edge 112. The lower jig pressing surface 220 may extend from the first lower jig edge 211 to the second lower jig edge 212.

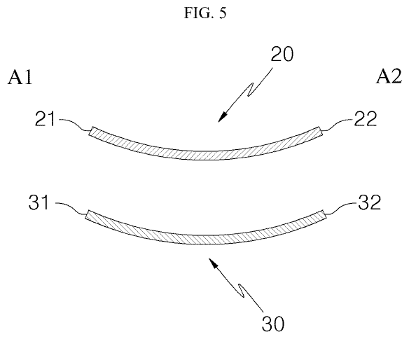

FIG. 5 is a view illustrating the layers illustrated in FIG. 3.

Referring to FIGS. 1 and 5, the layers 20 and 30 may be in the form of a plate or sheet shape. For example, the layers 20 and 30 may form the upper and lower surfaces.

The upper layer 20 may extend from one end to the other end. For example, a first upper layer edge 21 may form one end of the upper layer 20. For example, a second upper layer edge 22 may form the other end of the upper layer 20.

For example, the upper layer 20 may extend from the first upper layer edge 21 to the second upper layer edge 22. A direction in which the upper layer 20 extends may be the longitudinal direction of the upper jig pressing surface 120 (see FIG. 4).

The upper surface of the upper layer 20 may come into contact with the upper jig pressing surface 120 (see FIG. 4). The upper surface of the upper layer 20 may be concave. The lower surface of the upper layer 20 may be convex.

The lower layer 30 may extend from one end to the other end. For example, a first lower layer edge 31 may form one end of the lower layer 30. For example, a second lower layer edge 32 may form the other end of the lower layer 30.

For example, the lower layer 30 may extend from the first lower layer edge 31 to the second lower layer edge 32. A direction in which the lower layer 30 extends may be the longitudinal direction of the lower jig pressing surface 220 (see FIG. 4).

The lower surface of the lower layer 30 may face the lower jig pressing surface 220 (see FIG. 4). The upper surface of the lower layer 30 may be concave. The lower surface of the lower layer 30 may be convex.

The upper layer 20 and the lower layer 30 may be formed of materials different from each other. For example, the upper layer 20 may include cover glass. For example, the lower layer 30 may include a light emitting element layer and an optical clear adhesive (OCA). The lower layer 30 may be flexible. The lower layer 30 may be referred to as a display panel.

The light emitting element layer and OCA of the lower layer 30 may be laminated. For example, the light emitting element layer of the lower layer 30 may come into contact with the lower jig pressing surface 220 (see FIG. 4). For example, the OCA of the lower layer 30 may be applied to and laminate the light emitting element layer of the lower layer 30.

The upper layer edges 21 and 22 may include or mean at least one of the first upper layer edge 21 and the second upper layer edge 22. The lower layer edges 31 and 32 may include or mean at least one of the first lower layer edge 31 and the second lower layer edge 32.

In the present specification, the curvature may be set based on the longitudinal direction of the device 10 for assembling displays (see FIG. 4). For example, the curvature may be set based on a direction in which the upper jig 100 (see FIG. 4) faces the lower jig 200 (see FIG. 4).

For example, the curvature may be set based on a vertical direction. The lamination direction may be the direction in which the upper jig 100 (see FIG. 4) faces the lower jig 200 (see FIG. 4). The lamination direction may be, for example, the vertical direction.

For example, the curvature may be set based on a plane formed by the longitudinal direction of the device 10 for assembling displays (see FIG. 4) and the lamination direction. The reference plane may be the plane formed by the longitudinal direction of the device 10 for assembling displays (see FIG. 4) and the lamination direction.

In the present specification, the curvature radius may be the reciprocal of the curvature. For example, the product of the curvature radius and the curvature may be constant. For example, the product of the curvature radius and the curvature may be 1.

For example, the curvatures of layers 20 and 30 may mean the curvatures of the curves formed by the layers 20 and 30 on the reference plane.

For example, the curvature of the upper jig pressing surface 120 (see FIG. 4) may mean the curvature of a curve, wherein the upper jig pressing surface 120 (see FIG. 4) forms the curve on the reference plane.

For example, the curvature of the lower jig pressing surface 220 (see FIG. 4) may mean the curvature of a curve, wherein the lower jig pressing surface 220 (see FIG. 4) forms the curve on the reference plane.

For example, the curvature radius of the upper jig pressing surface 120 (see FIG. 4) may mean the curvature radius of the curve, wherein the upper jig pressing surface 120 (see FIG. 4) forms the curve on the reference plane.

For example, the curvature radius of the lower jig pressing surface 220 (see FIG. 4) may mean the curvature radius of the curve, wherein the lower jig pressing surface 220 (see FIG. 4) forms the curve on the reference plane.

Before the upper layer 20 and the lower layer 30 are pressed (e.g., by upper jig 100 and lower jig 200), the curvature of the upper layer 20 and the curvature of the lower layer 30 may be different from each other. For example, before the upper layer 20 and the lower layer 30 are pressed, the curvature of the upper layer 20 may be greater than the curvature of the lower layer 30. For example, before the upper layer 20 and the lower layer 30 are pressed, the lower layer 30 may be flatter than the upper layer 20.

For example, before the upper layer 20 and the lower layer 30 are pressed, the curvature of the lower layer 30 may be smaller than the curvature of the lower jig pressing surface 220 (see FIG. 4).

Referring to FIGS. 1 to 5, when the upper jig 100 and the lower jig 200 approach each other while the upper layer 20 and the lower layer 30 are spaced apart from each other, the upper layer 20 and the lower layer 30 may come into contact with each other.

When the upper jig 100 and the lower jig 200 approach each other while the upper layer 20 and the lower layer 30 are in contact with each other, the upper layer 20 and the lower layer 30 may receive pressure from the device 10 for assembling displays. For example, the upper layer 20 and the lower layer 30 may receive pressure in a direction in which the upper layer 20 and the lower layer 30 approach each other.

When the upper layer 20 and the lower layer 30 are pressed in the direction in which the upper layer 20 and the lower layer 30 approach each other, the upper layer 20 and the lower layer 30 may be adhered. For example, the OCA included in the lower layer 30 may be adhered to the upper layer 20.

In the process of receiving pressure by the lower layer 30, the lower layer 30 may be bent. For example, in the process of receiving pressure by the lower layer 30, the curvature of the lower layer 30 may increase.

In the process where the lower layer 30 is bent, stresses applied to regions adjacent to the lower layer edges 31 and 32 may be greater than the stress applied to a central portion of the lower layer 30.

Due to the laminated structure and non-uniformity of the stress distribution in the lower layer 30, in some cases, a greater pressure may be required in the regions adjacent to the lower layer edges 31 and 32 of the lower layer 30 in the process where the lower layer 30 is bent. In some aspects, the device 10 may apply a relatively greater pressure in the regions adjacent to the lower layer edges 31 and 32 of the lower layer 30 in the process where the lower layer 30 is bent.

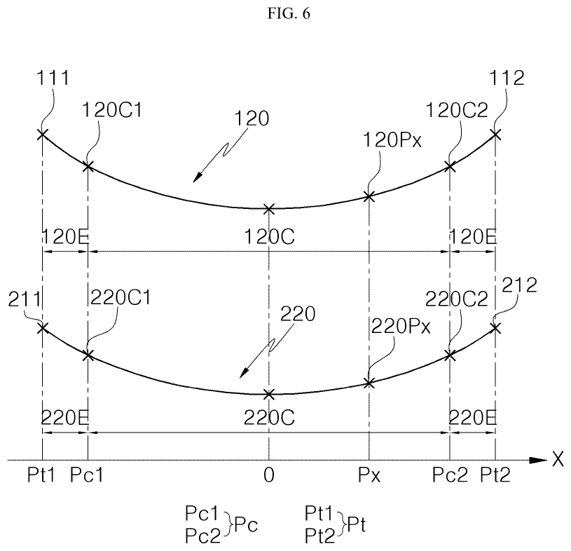

FIG. 6 is a view illustrating pressing surfaces depending on the position in the longitudinal direction of the device for assembling displays.

Referring to FIGS. 1 to 6, the pressing surfaces 120 and 220 may include or mean at least one of the upper jig pressing surface 120 and the lower jig pressing surface 220. The longitudinal direction of the device 10 for assembling displays may be the longitudinal direction of the upper jig 100 or the longitudinal direction of the lower jig 200.

In FIG. 6, the X-axis may represent the longitudinal direction of the device 10 for assembling displays. 0, which is a reference point on the X-axis, may be a center of the upper jig 100 or a center of the lower jig 200.

In another example, if the device 10 for assembling displays is asymmetrical on the X-axis, 0 on the X-axis may be set differently.

For example, the upper jig pressing surface 120 may extend horizontally from the first upper jig edge 111 to the second upper jig edge 112 by bending at one point. In this case, 0 on the X-axis may be the first upper jig edge 111.

Each point of the pressing surfaces 120 and 220 may correspond to a point on the X-axis. For example, an upper jig pressing surface point 120Px of the upper jig pressing surface 120 may correspond to a point Px on the X-axis. For example, a lower jig pressing surface point 220Px of the lower jig pressing surface 220 may correspond to the point Px on the X-axis.

For example, a first critical point Pc1 and a second critical point Pc2 may be points set on the X-axis. The critical point Pc may include or mean at least one of the first critical point Pc1 and the second critical point Pc2. The critical points (e.g., critical point Pc, first critical point Pc1, second critical point Pc2) described herein may correspond to boundaries between adjacent regions. For example, the first critical point Pc1 may correspond to a boundary between the lower jig pressing surface central region 220C and the lower jig pressing surface edge region 220E.

For example, a first limit point Pt1 and a second limit point Pt2 may be points set on the X-axis. The limit point Pt may include or mean at least one of the first limit point Pt1 and the second limit point Pt2.

The upper jig edges 111 and 112 may correspond to the limit point Pt. For example, the first upper jig edge 111 may correspond to the first limit point Pt1 of the upper jig pressing surface 120. For example, the second upper jig edge 112 may correspond to the second limit point Pt2 of the upper jig pressing surface 120. The upper jig edges 111 and 112 may include or mean at least one of the first upper jig edge 111 and the second upper jig edge 112.

The lower jig edges 211 and 212 may correspond to the limit point Pt. For example, the first lower jig edge 211 may correspond to the first limit point Pt1 of the lower jig pressing surface 220. For example, the second lower jig edge 212 may correspond to the second limit point Pt2 of the lower jig pressing surface 220. The lower jig edges 211 and 212 may include or mean at least one of the first lower jig edge 211 and the second lower jig edge 212.

A first upper jig pressing surface critical point 120C1 of the upper jig pressing surface 120 may correspond to the first critical point Pc1. A second upper jig pressing surface critical point 120C2 of the upper jig pressing surface 120 may correspond to the second critical point Pc2.

The first lower jig pressing surface critical point 220C1 of the lower jig pressing surface 220 may correspond to the first critical point Pc1. The second lower jig pressing surface critical point 220C2 of the lower jig pressing surface 220 may correspond to the second critical point Pc2.

The lower jig pressing surface critical points 220C1 and 220C2 may include or mean at least one of the first lower jig pressing surface critical point 220C1 and the second lower jig pressing surface critical point 220C2.

In the process where the lower layer 30 is bent, the stress applied to the lower layer 30 may vary depending on the point of the lower layer 30.

For example, a stress per unit area applied to a region from the points corresponding to the lower jig pressing surface critical points 220C1 and 220C2 of the lower layer 30 to the lower layer edges 31 and 32 may be greater than a stress per unit area applied to a region from the point corresponding to the first lower jig pressing surface critical point 220C1 to the point corresponding to the second lower jig pressing surface critical point 220C2 of the lower layer 30.

Inhomogeneity of the stress distribution per unit area formed in the lower layer 30 may cause a problem in forming the curvature of the lower layer 30. By forming the curvature distribution of the lower jig pressing surface 220 differently depending on the point, the problem entailed in forming the curvature of the lower layer 30 may be solved.

For example, a lower jig pressing surface central region 220C may be a region from the first lower jig pressing surface critical point 220C1 to the second lower jig pressing surface critical point 220C2 of the lower jig pressing surface 220.

For example, lower jig pressing surface edge regions 220E may be regions from the lower jig pressing surface critical points 220C1 and 220C2 of the lower jig pressing surface 220 to the lower jig edges 211 and 212, i.e., perimeters of the lower jig pressuring surface 220. The lower jig pressing surface edge regions 220E may extend from the lower jig pressing surface central region 220C to the lower jig edges 211 and 212, i.e., perimeters of the lower jig pressuring surface 220.

For example, an upper jig pressing surface central region 120C may be a region from the first upper jig pressing surface critical point 120C1 to the second upper jig pressing surface critical point 120C2 of the upper jig pressing surface 120.

For example, upper jig pressing surface edge regions 120E may be regions from the upper jig pressing surface critical points 120C1 and 120C2 to the upper jig edges 111 and 112 of the upper jig pressing surface 120. The upper jig pressing surface edge regions 120E may extend from the upper jig pressing surface central region 120C to the upper jig edges 111 and 112.

For example, the curvature of the lower jig pressing surface central region 220C may be the same as the curvature of the upper jig pressing surface central region 120C. For example, the curvature of the lower jig pressing surface edge region 220E may be greater than the curvature of the upper jig pressing surface edge region 120E.

Accordingly, a pressure per unit area applied to the region facing the lower jig pressing surface edge region 220E of the lower layer 30 may be greater than a pressure per unit area applied to the region facing the lower jig pressing surface central region 220C of the lower layer 30.

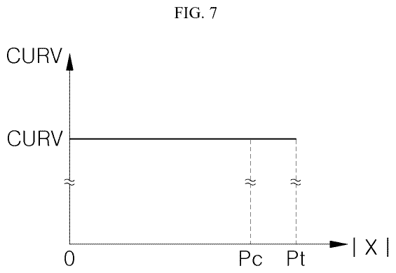

FIG. 7 is a graph illustrating a distribution of curvatures of the upper jig pressing surface illustrated in FIG. 6 on the X-axis.

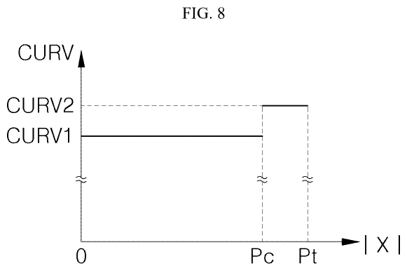

FIG. 8 is a graph illustrating a distribution of curvatures of the lower jig pressing surface illustrated in FIG. 6 on the X-axis.

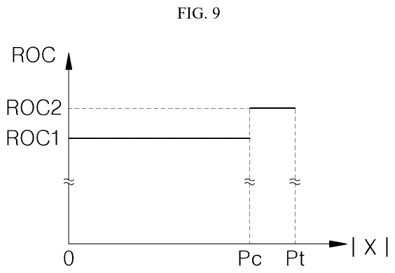

FIG. 9 is a graph illustrating a ratio of the curvature of the lower jig pressing surface illustrated in FIG. 8 to the curvature of the upper jig pressing surface illustrated in FIG. 7 on the X-axis.

Referring to FIGS. 1 to 9, the curvature of the upper jig pressing surface 120 may be constant as a first curvature CURV1. The curvature of the lower jig pressing surface 220 may vary depending on the corresponding point on the X-axis.

For example, the curvature of the lower jig pressing surface central region 220C may be the first curvature CURV1, and the curvature of the lower jig pressing surface edge region 220E may be a second curvature CURV2.

The second curvature CURV2 may be greater than the first curvature CURV1. That is, the curvature of the lower jig pressing surface edge region 220E may be greater than the curvature in the lower jig pressing surface central region 220C.

For example, the curvature in the lower jig pressing surface central region 220C may be the same as the curvature of the upper jig pressing surface 120. For example, the curvature in the lower jig pressing surface edge region 220E may be greater than the curvature in the upper jig pressing surface edge region 120E.

A curvature ratio ROC may be a ratio of the curvature of the lower jig pressing surface 220 to the curvature of the upper jig pressing surface 120 on the X-axis. The curvature ratio ROC may vary depending on the point on the X-axis.

For example, the curvature ratio ROC in the lower jig pressing surface central region 220C may be a first curvature ratio ROC1. The first curvature ratio ROC1 may be, for example, 1. For example, the curvature ratio ROC in the lower jig pressing surface edge region 220E may be a second curvature ratio ROC2. The second curvature ratio ROC2 may be greater than the first curvature ratio ROC1.

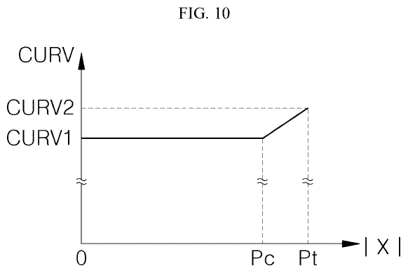

FIG. 10 is a graph illustrating the distribution of curvatures of the lower jig pressing surface illustrated in FIG. 6 on the X-axis, which is a graph illustrating a case where the curvature of a lower jig pressing surface edge region increases linearly.

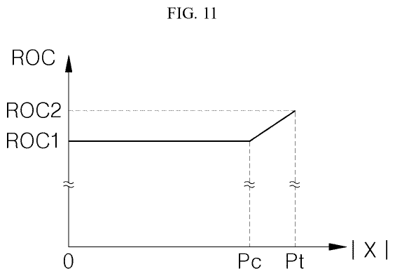

FIG. 11 is a graph illustrating a ratio of the curvature of the lower jig pressing surface illustrated in FIG. 10 to the curvature of the upper jig pressing surface illustrated in FIG. 7 on the X-axis.

Referring to FIGS. 1 to 7, 10 and 11, the curvature of the lower jig pressing surface central region 220C may be the same as the curvature of the upper jig pressing surface central region 120C. For example, the curvature of the lower jig pressing surface central region 220C may be the first curvature CURV1.

The curvature of the lower jig pressing surface edge region 220E may be different from the curvature of the upper jig pressing surface edge region 120E. For example, the curvature of the lower jig pressing surface edge region 220E may increase linearly from the critical point Pc toward the limit point Pt.

For example, the curvature of the lower jig pressing surface edge region 220E at the critical point Pc may be the first curvature CURV1, and the curvature of the lower jig pressing surface edge region 220E at the limit point Pt may be the second curvature CURV2.

The curvature ratio ROC in the lower jig pressing surface central region 220C may be the first curvature ratio ROC1. The first curvature ratio ROC1 may be, for example, 1.

The curvature ratio ROC of the lower jig pressing surface edge region 220E may vary depending on the point on the X-axis. For example, the curvature ratio ROC of the lower jig pressing surface edge region 220E may increase linearly from the critical point Pc toward the limit point Pt.

For example, the curvature ratio ROC of the lower jig pressing surface edge region 220E at the critical point Pc may be the first curvature ratio ROC1, and the curvature ratio ROC of the lower jig pressing surface edge region 220E at the limit point Pt may be the second curvature ratio ROC2.

Accordingly, for example, as the curvature ratio ROC of the lower jig pressing surface edge region 220E increases linearly toward the limit point Pt, the pressure per unit area applied to the edge region of the lower layer 30 may increase toward the edge of the lower layer 30. Thereby, the curvature of the lower layer 30 may be effectively formed.

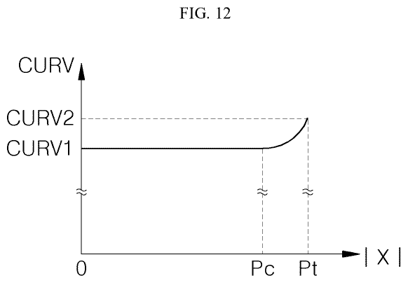

FIG. 12 is a graph illustrating the distribution of curvatures of the lower jig pressing surface illustrated in FIG. 6 on the X-axis, which is a graph illustrating a case where the curvature of the lower jig pressing surface edge region increases nonlinearly.

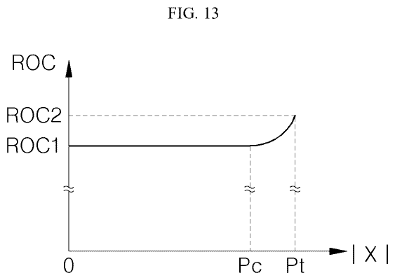

FIG. 13 is a graph illustrating a ratio of the curvature of the upper jig pressing surface illustrated in FIG. 7 to the curvature of the lower jig pressing surface illustrated in FIG. 12 on the X-axis.

Referring to FIGS. 1 to 7, 12 and 13, the curvature of the lower jig pressing surface central region 220C may be the same as the curvature of the upper jig pressing surface central region 120C. For example, the curvature of the lower jig pressing surface central region 220C may be the first curvature CURV1.

For example, a distance between the upper jig pressing surface point 120Px in the upper jig pressing surface central region 120C and the lower jig pressing surface point 220Px in the lower jig pressing surface central region 220C may be constant.

The curvature of the lower jig pressing surface edge region 220E may be different from the curvature of the upper jig pressing surface edge region 120E. For example, the curvature of the lower jig pressing surface edge region 220E may increase nonlinearly from the critical point Pc toward the limit point Pt.

In the present specification, a distance between the upper jig pressing surface 120 and the lower jig pressing surface 220 may be set based on the reference plane. For example, the distance between the upper jig pressing surface 120 and the lower jig pressing surface 220 may mean a distance between two curves, wherein the upper jig pressing surface 120 and the lower jig pressing surface 220 form the two curves on the reference plane, respectively.

For example, a distance between the lower jig pressing surface point 220Px in the lower jig pressing surface edge region 220E and the upper jig pressing surface point 120Px in the upper jig pressing surface edge region 120E may vary depending on the point Px on the X-axis.

For example, the distance between the lower jig pressing surface point 220Px in the lower jig pressing surface edge region 220E and the upper jig pressing surface point 120Px in the upper jig pressing surface edge region 120E may decrease nonlinearly from the critical point Pc toward the limit point Pt.

For example, the curvature of the lower jig pressing surface edge region 220E at the critical point Pc may be the first curvature CURV1, and the curvature of the lower jig pressing surface edge region 220E at the limit point Pt may be the second curvature CURV2.

The curvature ratio ROC of the lower jig pressing surface edge region 220E may vary depending on the point on the X-axis. For example, the curvature ratio ROC of the lower jig pressing surface edge region 220E may increase nonlinearly from the critical point Pc toward the limit point Pt.

For example, the curvature ratio ROC of the lower jig pressing surface edge region 220E at the critical point Pc may be the first curvature ratio ROC1, and the curvature ratio ROC of the lower jig pressing surface edge region 220E at the limit point Pt may be the second curvature ratio ROC2.

For example, a degree at which the distance between the lower jig pressing surface point 220Px in the lower jig pressing surface edge region 220E and the upper jig pressing surface point 120Px in the upper jig pressing surface edge region 120E decreases may increase toward the lower jig edges 211 and 212.

Accordingly, for example, as the curvature ratio ROC of the lower jig pressing surface edge region 220E increases nonlinearly toward the limit point Pt, the pressure applied to the lower layer 30 may be relatively concentrated on the edges of the lower layer 30. Thereby, the curvature of the lower layer 30 may be effectively formed.

What is claimed is:

1. A device for assembling displays, the device comprising:
an upper jig comprising an upper jig pressing surface, wherein the upper jig pressing surface extends from a first upper jig edge to a second upper jig edge in a longitudinal direction of the device and is convex downward; and
a lower jig positioned below the upper jig and comprising a lower jig pressing surface, wherein the lower jig pressing surface extends from a first lower jig edge to a second lower jig edge in the longitudinal direction, is concave and faces the upper jig pressing surface, and has a curvature which varies along the lower jig pressing surface in the longitudinal direction.

2. The device for assembling displays according to claim 1, wherein:
a reference plane is formed in the longitudinal direction and a vertical direction, and
the curvature of the lower jig pressing surface is a curvature of a curve formed by the lower jig pressing surface on the reference plane.

3. The device for assembling displays according to claim 1, wherein the lower jig pressing surface comprises:
a lower jig pressing surface central region forming a central portion of the lower jig pressing surface; and
a lower jig pressing surface edge region extending from the lower jig pressing surface central region to a perimeter of the lower jig pressing surface.

4. The device for assembling displays according to claim 3, wherein a curvature of the lower jig pressing surface edge region is greater than a curvature of the lower jig pressing surface central region.

5. The device for assembling displays according to claim 4, wherein the curvature of the lower jig pressing surface edge region increases in a direction from a boundary between the lower jig pressing surface central region and the lower jig pressing surface edge region to the perimeter of the lower jig pressing surface.

6. The device for assembling displays according to claim 4, wherein the curvature of the lower jig pressing surface at a boundary between the lower jig pressing surface central region and the lower jig pressing surface edge region is smaller than the curvature of the lower jig pressing surface at the perimeter of the lower jig pressing surface.

7. The device for assembling displays according to claim 3, wherein the upper jig pressing surface comprises:
an upper jig pressing surface central region facing the lower jig pressing surface central region; and
an upper jig pressing surface edge region extending from the upper jig pressing surface central region to a perimeter of the upper jig pressing surface.

8. The device for assembling displays according to claim 7, wherein:
a curvature ratio is defined as a ratio of the curvature of the lower jig pressing surface to a curvature of the upper jig pressing surface in the longitudinal direction, and
the curvature ratio in the lower jig pressing surface central region is constant along the lower jig pressing surface in the longitudinal direction.

9. The device for assembling displays according to claim 8, wherein the curvature ratio in the lower jig pressing surface edge region is greater than the curvature ratio in the lower jig pressing surface central region.

10. The device for assembling displays according to claim 8, wherein the curvature ratio in the lower jig pressing surface edge region increases in a direction from a boundary between the lower jig pressing surface central region and the lower jig pressing surface edge region to the perimeter of the lower jig pressing surface.

11. A device for assembling displays, the device comprising:
an upper jig comprising an upper jig pressing surface, wherein the upper jig pressing surface extends from a first upper jig edge to a second upper jig edge in a longitudinal direction of the device and is convex downward; and
a lower jig positioned below the upper jig and comprising a lower jig pressing surface, wherein the lower jig pressing surface extends from a first lower jig edge to a second lower jig edge in the longitudinal direction, is concave, and faces the upper jig pressing surface,
wherein a distance between the upper jig pressing surface and the lower jig pressing surface varies along the upper jig pressing surface and the lower jig pressing surface in the longitudinal direction.

12. The device for assembling displays according to claim 11, wherein:
a reference plane is formed in the longitudinal direction and a vertical direction, and
a distance between the upper jig pressing surface and the lower jig pressing surface is a distance between two curves respectively formed on the reference plane by the upper jig pressing surface and the lower jig pressing surface.

13. The device for assembling displays according to claim 11, wherein the lower jig pressing surface comprises:
a lower jig pressing surface central region forming a central portion of the lower jig pressing surface; and
a lower jig pressing surface edge region extending from the lower jig pressing surface central region to a perimeter of the lower jig pressing surface.

14. The device for assembling displays according to claim 13, wherein the upper jig pressing surface comprises:
an upper jig pressing surface central region facing the lower jig pressing surface central region; and
an upper jig pressing surface edge region extending from the upper jig pressing surface central region to a perimeter of the upper jig pressing surface.

15. The device for assembling displays according to claim 14, wherein a distance between the upper jig pressing surface central region and the lower jig pressing surface central region is constant along the lower jig pressing surface in the longitudinal direction.

16. The device for assembling displays according to claim 15, wherein a distance between the upper jig pressing surface edge region and the lower jig pressing surface edge region decreases in a direction from a boundary between the lower jig pressing surface edge region and the lower jig pressing surface central region to the perimeter of the lower jig pressing surface.

17. A device for assembling displays, the device comprising:
an upper jig comprising an upper jig pressing surface, wherein the upper jig pressing surface extends from a first upper jig edge to a second upper jig edge in a longitudinal direction of the device and is convex downward; and
a lower jig positioned below the upper jig and comprising a lower jig pressing surface, wherein the lower jig pressing surface extends from a first lower jig edge to a second lower jig edge in the longitudinal direction, is concave and faces the upper jig pressing surface, and has a curvature radius which varies along the lower jig pressing surface in the longitudinal direction.

18. The device for assembling displays according to claim 17, wherein:
a reference plane is formed in the longitudinal direction and a vertical direction, and
the curvature radius of the lower jig pressing surface is a curvature radius of a curve formed by the lower jig pressing surface on the reference plane.

19. The device for assembling displays according to claim 18, wherein the lower jig pressing surface comprises:
a lower jig pressing surface central region forming a central portion of the lower jig pressing surface; and
a lower jig pressing surface edge region extending from the lower jig pressing surface central region to a perimeter of the lower jig pressing surface,
wherein a curvature radius of the lower jig pressing surface edge region is smaller than a curvature radius of the lower jig pressing surface central region.

20. The device for assembling displays according to claim 19, wherein a curvature of the lower jig pressing surface at a boundary between the lower jig pressing surface central region and the lower jig pressing surface edge region is smaller than a curvature of the lower jig pressing surface at the perimeter of the lower jig pressing surface.
